(19) United States
(12) Patent Application Publication
(10) Pub. No.: US 2004/0094020 A1
(43) Pub. Date: May 20, 2004

(54) Method and system for streaming human voice and instrumental sounds

(75) Inventors: Ye Wang, Kent Vale (SG); Matti Hamalainen, Lempaala (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/302,746

(22) Filed: Nov. 20, 2002

(51) Int. Cl. G10H 1/06; G10H 7/00

(52) U.S. Cl. 84/622

(57) ABSTRACT

A method and device for audio streaming, wherein audio signals indicative of voice are encoded by a voice-specific encoder (such as AMR-WB) and embedded in a first bitstream, and audio signals indicative of instrumental sounds are encoded by a different encoder, such as an SP-MIDI synthesizer, and embedded in a second bitstream for transmission. In the decoder, a voice-specific decoder is used to reconstruct the voice signals based on the first bitstream, and a synthesizer-type decoder is used to reconstruct the instrumental sounds based on the second bitstream. The reconstructed voice signals and the reconstructed instrumental sounds are dynamically mixed for playback.

### FIELD OF THE INVENTION

The present invention relates generally to audio streaming and, more particularly, to audio coding for speech, singing voice and associated instrumental music.

### BACKGROUND OF THE INVENTION

In an electronic device such as a mobile phone, the audio codec is not designed for streaming music together with voice in wireless peer-to-peer communications. If music and voice were to be sent together to a receiving end, the bandwidth and audio quality would suffer. This is mainly due to typical transmission errors in wireless networks and their effects on general purpose audio codecs and playback devices.

Applications of peer-to-peer audio streaming involving voice and music can be found in karaoke, for example, where an impromptu singer picks up a microphone to sing a song along with instrumental music background, and the singing voice is mixed with the background music and played on a speaker system. The same streaming can be found when a user sings into a mobile phone along with some background music to entertain the person on the receiving end.

It is advantageous and desirable to provide a method and system for streaming audio signals including human voice and instrumental sounds between portable electronic devices, such as mobile terminals, communicators and the like.

### SUMMARY OF THE INVENTION

It is a primary objective of the present invention to provide a method and system for audio streaming having both the benefits of bandwidth efficiency and error robustness in the delivery of a structured audio presentation containing speech, natural audio and synthetic audio signals. This objective can be achieved by using two different types of codecs to separately stream synthetic audio signals and natural audio signals.

According to the first aspect of the present invention, there is provided a method of audio streaming between at least a first electronic device and a second electronic device, wherein a first audio signal and a second audio signal having different audio characteristics are encoded in the first electronic device for providing audio data to the second electronic device. The method is characterized by

encoding the first audio signal in a first audio format, by

embedding the encoded first audio signal in the audio data, by

encoding the second audio signal in a second audio format different from the first audio format, and by

embedding the encoded second audio signal in the audio data, so as to allow the second electronic device to separately reconstruct the first audio signal based on the encoded first audio signal and reconstruct the second audio signal based on the encoded second audio signal.

The first and second electronic devices include mobile phones or other mobile media terminals.

The method is further characterized by mixing the reconstructed the first audio signal and the second audio signal in the second electronic device.

The method is further characterizes by synchronizing the encoded first audio signal and the encoded second audio signal prior to said mixing.

Preferably, the first audio signal is indicative of a voice and the second audio signal is indicative of an instrumental sound.

Advantageously, the second audio format comprises a synthetic audio format, and the first audio format comprises a wideband audio codec format.

The method is further characterized by transmitting the audio data to the second electronic device in a wireless fashion.

Advantageously, the audio data comprises a first audio data indicative of the encoded first audio signal and a second audio data indicative of the encoded second audio signal, wherein the first audio data and the second audio data are transmitted to the second electronic device substantially in the same streaming session.

Preferably, the audio data comprises a first audio data indicative of the encoded first audio signal and a second audio data indicative of the encoded second audio signal, wherein the second audio data is transmitted to the second electronic device before the first audio data is transmitted to the second electronic device, so as to allow the second electronic device to reconstruct the second audio signal based on the stored second audio data at a later time.

Preferably, when the transmitted audio data contains transmission errors, the transmission errors in the first audio signal and in the second audio signal are separately concealed prior to mixing.

Preferably, the first audio signal and second audio signal are generated in the first electronic device substantially in the same streaming session.

Alternatively, the second audio format comprises a synthetic audio format and the second audio signal is generated in the first electronic device based on a stored data file.

Advantageously, the encoded first audio signal and the encoded second audio signal are embedded in the same data stream for providing the audio data, or the encoded first audio signal and the encoded second audio signal are embedded in two separate data streams for providing the audio data.

According to the second aspect of the present invention, there is provided an audio coding system for coding audio signals including a first audio signal and a second audio signal having different audio characteristics. The coding system is characterized by

a first encoder for encoding the first audio signal for providing a first stream in a first audio format, by

a second encoder for encoding the second audio signal for providing a second stream in a second audio format, by

a first decoder, responsive to the first stream, for reconstructing the first audio signal based on the encoded first audio signal, by

a second decoder, responsive to the second stream, for reconstructing the second audio signal based on the encoded second audio signal, and by

a mixing module for combining the reconstructed first audio signal and the reconstructed second audio signal.

Preferably, the second audio format is a synthetic audio format and the coding system comprises a synthesizer for generating the second audio signal.

Advantageously, the coding system comprises a storage module for storing a data file so as to allow the synthesizer to generate the second audio signal based on the stored data file.

Advantageously, the coding system comprises a storage module for storing data indicative of the encoded audio signal provided in the second stream so as to allow the second decoder to reconstruct the second audio signal based on the stored data.

According to the third aspect of the present invention, there is provided an electronic device capable of coding audio signals for audio streaming, the audio signals including a first audio signal and a second audio signal having different audio characteristics. The electronic device is characterized by

a voice input device for providing signals indicative of the first audio signal,

a first audio coding module for encoding the first audio signal for providing a first stream in a first audio format,

a second audio coding module for providing a second stream indicative of the second audio signal in a second audio format, and

means, for transmitting the first and second streams in a wireless fashion, so as to allow a different electronic device to separately reconstruct the first audio signal using a first audio coding module and the second audio signal using a second audio coding module.

The electronic device, according to the present invention, includes a mobile phone.

The present invention will become apparent upon reading the description taken in conjunction with FIGS. 1-4b.

### BRIEF DESCRIPTION OF THE DRAWINGS

FIG. 1 is a schematic representation illustrating audio streaming between two mobile media terminals, according to the present invention.

FIG. 2 is a schematic representation illustrating audio streaming between two media terminals, according to another embodiment of the present invention.

FIG. 3a is a schematic representation illustrating a mobile media terminal capable of transmitting and receiving audio data streams being used as a transmitting end.

FIG. 3b is a schematic representation illustrating the same mobile media terminal being used as a receiving end.

FIG. 4a is a schematic representation showing a storage device in a mobile media terminal.

FIG. 4b is a schematic representation illustrating a terminal capable of receiving MIDI data from an external device.

### BEST MODE TO CARRY OUT THE INVENTION

Currently, a synthetic audio-type audio codec such as MIDI (Musical Instrument Digital Interface) is available on some terminal devices. This invention refers to MIDI and, more particularly, Scalable Polyphony MIDI (SP-MIDI) as a favorable synthetic audio format. Unlike General MIDI where the polyphony requirements are fixed, SP-MIDI provides a mechanism for scalable MIDI playback at different polyphony levels. As such, SP-MIDI allows a composer to deliver a single audio file that can be played back on MIDI-based mobile devices with different polyphony capabilities. Thus, a device equipped with an 8-note polyphony SP-MIDI can be used to play back an audio file delivered from a 32-note polyphony coder. SP-MIDI is also used in a mobile phone for producing ringing tones, game sounds and messaging. However, SP-MIDI does not offer the sound quality usually required for streaming natural audio signals, such as human voice.

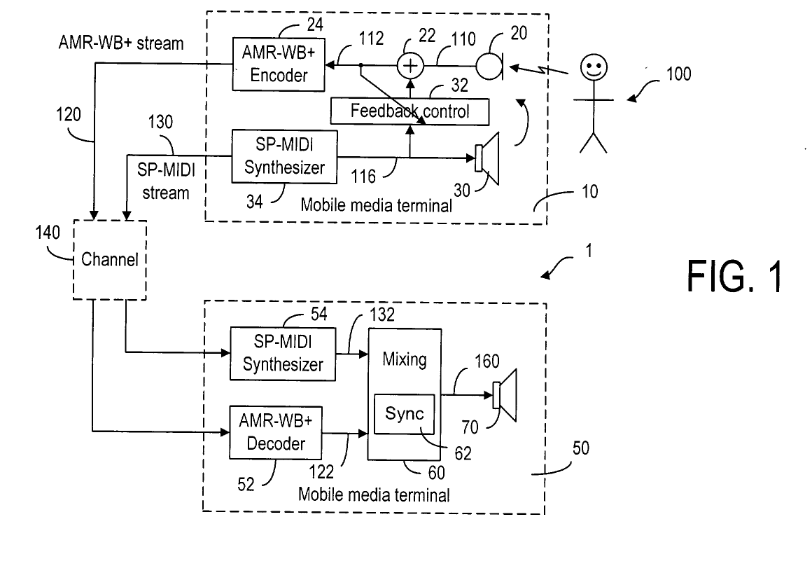

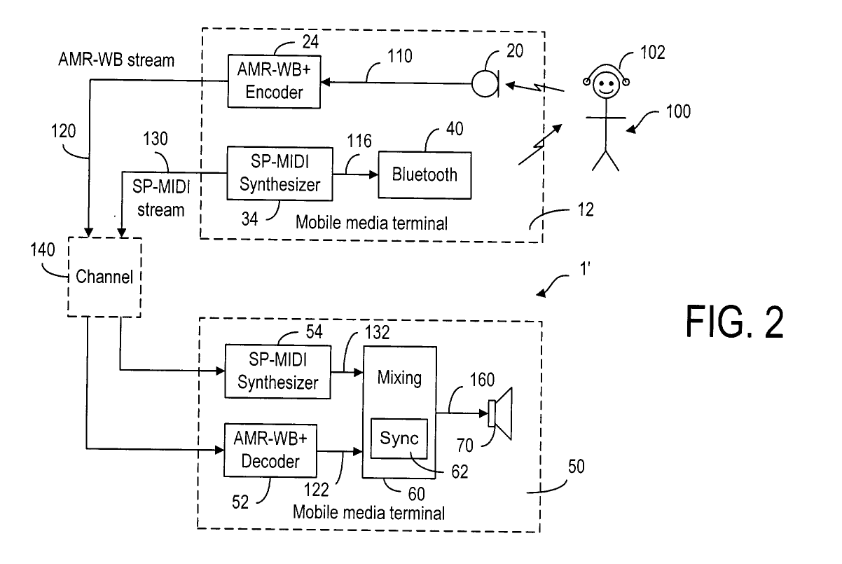

The present invention provides a method of audio streaming wherein a first stream, including audio data encoded in a synthetic audio format, and a second stream, including audio data encoded in a different audio format, such as AMR-WB (Adaptive Multi-Rate Wideband), are provided to a receiver where the first and second streams are separately decoded prior to mixing. The present invention is illustrated in FIGS. 1 and 2.

FIG. 1 is schematic representation illustrating the streaming of a karaoke song and background music using AMR-WB and SP-MIDI encoders. As shown, a user 100 uses the microphone 20 in a first mobile media terminal 10 in a system 1 to sing or speak. An SP-MIDI synthesizer 34 is used to play background music through a loudspeaker 30 based on audio signal 116. The SP-MIDI synthesizer 34 also provides an SP-MIDI stream 130 indicative of the background music through a channel 140. The channel 140 can be a wireless medium. At the receiver side, a second mobile media terminal 50 is used for playback. The second mobile media terminal 50 has an SP-MIDI synthesizer 54 for decoding the SP-MIDI stream 130, and a separate AMR-WB decoder 52 for decoding the AMR-WB stream. The synthesized audio samples 132 and the reconstructed natural audio samples 122 are dynamically mixed by a mixer module 60 and the mixed PCM samples 160 are played on a speaker 70. It should be noted that the microphone 20 in the first mobile media terminal 10 also picks up the musical sound from the loudspeaker 30. Thus, the audio signals 110 contain both the user's voice and the background music. It is preferred that a mixer 22, through a feedback control 32, is used to reduce or eliminate the background music part in the audio signals 110. As such, the audio signals 112 mainly contain signals indicative of the user's voice. The mixer 22 and the feedback control 32 are used as a MIDI sound cancellation device to suppress the MIDI sound picked up by the microphone 20. The cancellation is desirable for two reasons. Firstly, the MIDI sounds from the two streams 120, 130 may be slightly different, and the mixing of two slightly MIDI sounds may yield an undesirable results at the receiver terminal 50 and secondly the coding efficiency and audio quality of the AMR-WB codec would be degraded by the music since the codec has a superior performance when coding of speech and singing voice alone.

The background music from the SP-MIDI 34 can be provided to the user 100 in a different way. For example, a local transmitter, such as a bluetooth device 40, can be used to send signals indicative of the background music to the user 100 via a bluetooth compatible headphone 102, as shown in FIG. 2. As such, the microphone 20 in the mobile media terminal 12 is not likely to pick up a significant amount of background music.

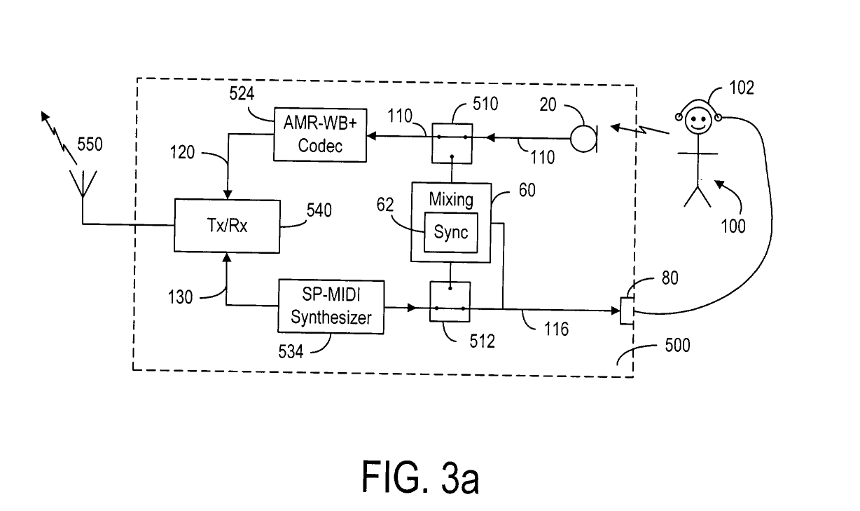

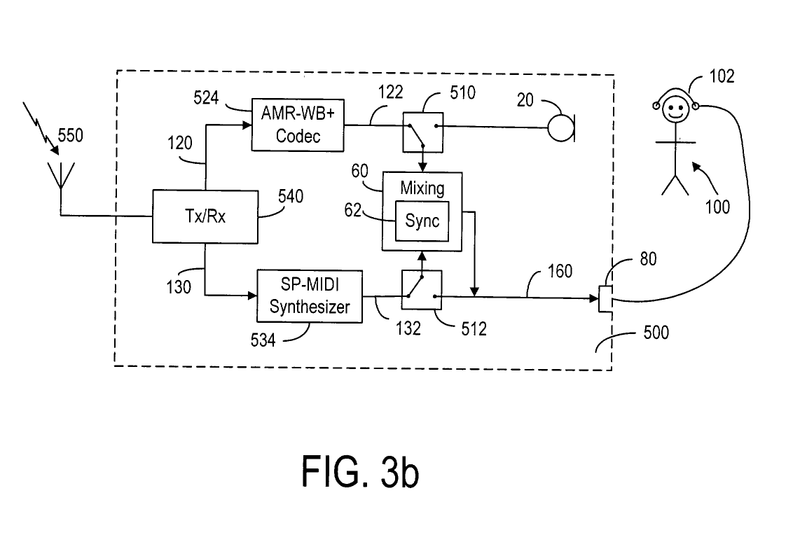

A mobile media terminal, such as a mobile phone, can be used to transmit and to receive data indicative of audio signals, as shown in FIGS. 3a and 3b. The mobile media terminal 500, as shown in FIGS. 3a and 3b, comprises an AMR-WB codec 524 and an SP-MIDI codec or synthesizer 534 operatively connected to a transceiver 540 and an antenna 550. The mobile media terminal 500 further comprises a switching module 510 and a switching module 512. The switching module 510 is used to provide a signal connection between the AMR-WB codec 524 and the microphone 20, as shown in FIG. 3a, or between the AMR-WB codec 524 and the mixing module 60, as shown in FIG. 3b. The mobile media terminal 500 can have a speaker 30 and MIDI suppressor (22, 32), as shown in FIG. 1, or a bluetooth device 40, as shown in FIG. 2. Alternatively, the mobile media terminal 500 comprises an audio connector 80, which can be connected to the headphone 102, as shown in FIGS. 3a and 3b. The switching module 512 is used to provide a signal connection between the SP-MIDI synthesizer 534 and the audio connector 80, as shown in FIG. 3a, or between the SP-MIDI synthesizer 534 and the mixing module 60, as shown in FIG. 3b. When the mobile media terminal 500 is used in a transmitting end, as shown in FIG. 3a, the speaker is connected to the AMR-WB codec to allow the user to input voice in the terminal. At the same time, the background music from the SP-MIDI synthesizer 534 is provided directly to the audio connector 80. Thus, the mixing module 60 is bypassed. When the mobile media terminal 500 is used in a receiving end, as shown in FIG. 3b, the microphone 20 is effectively disconnected, while the mixing module 60 is operatively connected to the AMR-WB codec 524. As such, the mobile media terminal 500 functions like the mobile media terminal 50, as shown in FIGS. 1 and 2.

The present invention provides a method and device for audio streaming wherein voice and instrumental sounds are coded separately with efficient techniques in order to achieve a desirable quality in audio sounds and error robustness for a given bitrate. SP-MIDI is an audio format especially designed for handheld devices with limited memory and computational capacity. An SP-MIDI with a bitrate of 2 kbps can be used to efficiently encode the sounds of drumbeats, for example. If the channel capacity for streaming is 24 kbps and SP-MIDI bitrate is 2 kbps, this allows us to use an AMR-WB or some other voice-specific coding scheme to encode the voice with 18 kbps or less and leave over 4 bps for error protection. With ample room for error protection, it is preferred to use a better error-correction code, or even a data retransmission scheme, to protect the SP-MIDI stream 130. As such, most errors will take place in the AMR-WB packets. Errors due to AMR-WB packet loss can be concealed using a conventional method, such as interpolation from neighboring packets, to recover the corrupted voice.

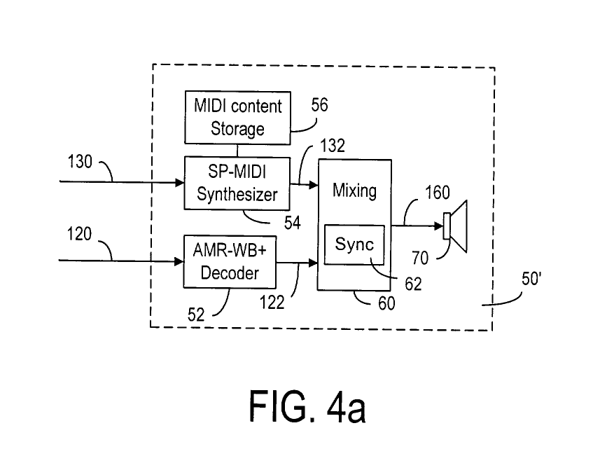

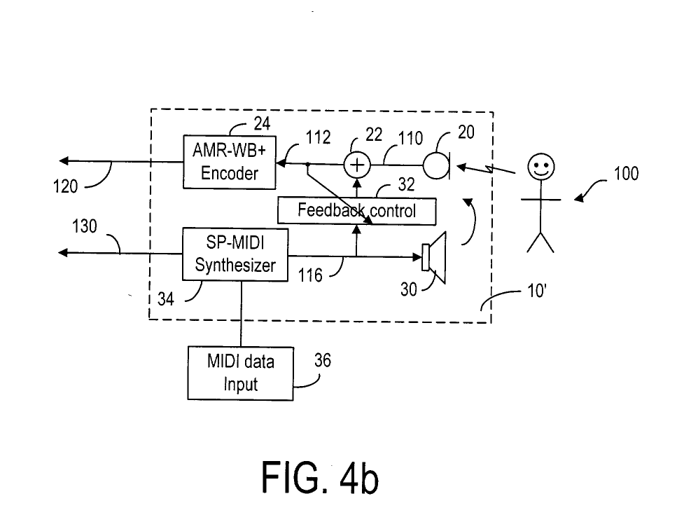

It should be noted that it is necessary to synchronize the two bitstreams 120 and 130 so that the voice and accompaniment are rendered correctly in time at the receiver mobile media terminal 50. These bitstreams can be synchronized in a synchronization module 62 using a time stamp or a similar technique. However, it is generally feasible to upload the SP-MIDI bitstream 130 to a playback terminal prior to playback. This is because the file size, in general, is small enough to be stored entirely in the terminal. In that case, retransmission of the bitstream 130 can be carried out in order to minimize transmission errors. MIDI content requires a transmission channel that is robust against transmission errors. Thus, prior upload and retransmission is one simple way to solve the transmission error problem. It is understood that in order to store the MIDI content received by the terminal prior to playback, the terminal 50′ has a storage module 56, as shown in FIG. 4a. Likewise, the terminal 10, as shown in FIGS. 1 and 2, has a storage module to store a data file so as to allow the SP-MIDI synthesizer to generate the SP-MIDI stream 130 based on the stored data file.

In general, any transmission channel that can support a predictable transmission data rate and sufficient QoS (Quality of Service) for audio streaming can be used as the channel 140. The SP-MIDI content and the AMR-WB data can be streamed separately as two streams or together as a combined stream. SP-MIDI delivery can utilize a separate protocol, such as SIP (Session Initiation Protocol), to manage the delivery of necessary synthetic audio content. However, it is advantageous to use prior upload and retransmission of SP-MIDI content to increase the robustness of data transmission.

The present invention has been disclosed in conjunction with the use of a synthetic audio-type codec and a voice-specific type codec for separately coding two audio signals with different characteristics into two separate bitstreams for transmission. It is understood that any two types of codecs can be used to carry out the invention so long as each of the two types is efficient in coding a different audio signal. Furthermore, the voice in one stream can be a human voice, as in singing, speaking, whistling or humming. The voice can be from a live performance or from a recorded source. The instrumental sounds can contain both the musical score, e.g. SP-MIDI, and possible instrument data, e.g. Downloadable Sounds (DLS) instrument data, to produce melodic or beat-like sounds produced by percussive instruments and non-percussive instruments. They can also be sounds produced by an electronic device such as a synthesizer.

It should also be noted that in some applications, MIDI content is generated in advance of the streaming session. As such, the SP-MIDI file can be stored in the playback terminal. In some applications, however, MIDI content is obtained from a live performance, for example. As such, MIDI content is generated contemporaneously with audio signals provided to the AMR-WB encoder. For example, it is feasible to generate MIDI content with the SP-MIDI synthesizer 34 in a terminal 10′ based on the music data provided by a MIDI input device 36, as shown in FIG. 4b.

It should be noted that in the transmission of encoded audio signals, errors may occur. Thus, it is preferred that errors are concealed prior to mixing the reconstructed audio signals by the mixing module 60 in the receiver terminal 50, 50′. Furthermore, it is possible to split an audio stream into a number of audio streams in audio streaming. Thus, one synchronized stream, according to the present invention, is generally defined to include one multichannel audio stream and several synchronized audio streams.

Thus, although the invention has been described with respect to a preferred embodiment thereof, it will be understood by those skilled in the art that the foregoing and various other changes, omissions and deviations in the form and detail thereof may be made without departing from the scope of this invention.

What is claimed is:

1. A method of audio streaming between at least a first electronic device and a second electronic device, wherein a first audio signal and a second audio signal having different audio characteristics are encoded in the first electronic device for providing audio data to the second electronic device, said method characterized by
encoding the first audio signal in a first audio format, by
embedding the encoded first audio signal in the audio data, by
encoding the second audio signal in a second audio format different from the first audio format, and by
embedding the encoded second audio signal in the audio data, so as to allow the second electronic device to separately reconstruct the first audio signal based on the encoded first audio signal and reconstruct the second audio signal based on the encoded second audio signal.

2. The method of claim 1, further characterized by mixing the reconstructed first audio signal and second audio signal in the second electronic device.

3. The method of claim 2, further characterized by synchronizing the encoded first audio signal and the encoded second audio signal prior to said mixing.

4. The method of claim 1, characterized in that the first audio signal is indicative of a voice and the second audio signal is indicative of an instrumental sound.

5. The method of claim 4, characterized in that the second audio format comprises a synthetic audio format.

6. The method of claim 4, characterized in that the first audio format comprises a wideband audio codec format.

7. The method of claim 1, further characterized by
transmitting the audio data to the second electronic device.

8. The method of claim 7, characterized in that the audio data is transmitted in a wireless manner.

9. The method of claim 7, characterized in that the audio data comprises a first audio data indicative of the encoded first audio signal and a second audio data indicative of the encoded second audio signal, wherein the first audio data and the second audio data are transmitted to the second electronic device substantially in the same streaming session.

10. The method of claim 7, characterized in that the audio data comprises a first audio data indicative of the encoded first audio signal and a second audio data indicative of the encoded second audio signal, wherein the second audio data is transmitted to the second electronic device before the first audio data is transmitted to the second electronic device.

11. The method of claim 10, characterized in that the second electronic device has means to store the second audio data so as to allow the second electronic device to reconstruct the second audio signal based on the stored second audio data at a later time.

12. The method of claim 11, characterized in that the second audio format comprises a synthetic audio format.

13. The method of claim 1, characterized in that the first audio signal and second audio signal are generated in the first electronic device substantially in the same streaming session.

14. The method of claim 1, characterized in that the second audio format comprises a synthetic audio format and the second audio signal is generated in the first electronic device based on a stored data file.

15. The method of claim 1, characterized in that the encoded first audio signal and the encoded second audio signal are embedded in the same data stream for providing the audio data.

16. The method of claim 1, characterized in that the encoded first audio signal and the encoded second audio signal are embedded in two separate data streams for providing the audio data.

17. The method of claim 1, further characterized by
transmitting the audio data to the second electronic device, by
concealing transmission errors in the audio data, if necessary, and by
mixing the reconstructed first audio signal and second audio signal in the second electronic device.

18. The method of claim 17, further characterized in that
the transmission errors in the encoded first audio signal and in the encoded second audio signal are separately concealed prior to said mixing.

19. The method of claim 1, wherein the first electronic device comprises a mobile phone.

20. The method of claim 1, wherein the second electronic device comprises a mobile phone.

21. An audio coding system for coding audio signals including a first audio signal and a second audio signal having different audio characteristics, said coding system characterized by
a first encoder for encoding the first audio signal for providing a first stream in a first audio format, by
a second encoder for encoding the second audio signal for providing a second stream in a second audio format, by
a first decoder, responsive to the first stream, for reconstructing the first audio signal based on the encoded first audio signal, by
a second decoder, responsive to the second stream, for reconstructing the second audio signal based on the encoded second audio signal, and by
a mixing module for combining the reconstructed first audio signal and the reconstructed second audio signal.

22. The coding system of claim 21, characterized in that the second audio format is a synthetic audio format.

23. The coding system of claim 22, further characterized by
a synthesizer for generating the second audio signal.

24. The coding system of claim 23, further characterized by
a storage module for storing a data file so as to allow the synthesizer to generate the second audio signal based on the stored data file.

25. The coding system of claim 23, further characterized by
a storage module for storing data indicative of the encoded audio signal provided in the second stream so as to allow the second decoder to reconstruct the second audio signal based on the stored data.

26. An electronic device capable of coding audio signals for audio streaming, the audio signals including a first audio signal and a second audio signal having different audio characteristics, said electronic device comprising:
a voice input device for providing signals indicative of the first audio signal,
a first audio coding module for encoding the first audio signal for providing a first stream in a first audio format,
a second audio coding module for providing a second stream indicative of the second audio signal in a second audio format, and
means, for transmitting the first and second streams in a wireless fashion, so as to allow a different electronic device to separately reconstruct the first audio signal using a first audio coding module and the second audio signal using a second audio coding module.

27. The electronic device of claim 26, comprising a mobile phone.
